(19) United States
(12) Patent Application Publication
(10) Pub. No.: US 2008/0145723 A1
(43) Pub. Date: Jun. 19, 2008

(54) Rechargeable fuel cell and method

(75) Inventors: Shengxian Wang, Shanghai (CN); Andrew Philip Shapiro, Schenectady, NY (US); Jun Cai, Shanghai (CN); Hai Yang, Shanghai (CN); Rihua Xiong, Shanghai (CN); Chang Wei, Niskayuna, NY (US); Bing Zhang, Shanghai (CN); Qunjian Huang, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/639,941

(22) Filed: Dec. 15, 2006

(51) Int. Cl. H01M 8/06; H01M 8/02

(52) U.S. Cl. 429/17; 429/12; 429/34; 429/13

(57) ABSTRACT

An apparatus for controlling humidity in a fuel cell is provided. The apparatus can include a housing having an interior surface defining a volume and containing at least one fuel cell disposed within the volume. The apparatus may also include a plurality of electrodes disposed within the volume. The apparatus can include an aperture defined by the housing through which at least one air gas stream can be in fluid communication with at least one of the plurality of electrodes. The apparatus can include a humidity-controlling component, wherein the humidity-controlling component is in fluid communication with the air gas stream prior to the air gas stream contacting the at least one of the plurality of electrodes, and humidity-controlling component being capable of controlling a relative humidity of the air gas stream. A method for controlling humidity in a fuel cell is provided.

### BACKGROUND

1. Technical Field

An embodiment of the invention may relate to a fuel cell or secondary battery. An embodiment of the invention may relate to a method associated with a fuel cell or secondary battery.

2. Discussion of Related Art

Water loss constitutes an obstacle to optimal performance of rechargeable fuel cells and secondary batteries. In a rechargeable fuel cell, metal hydride may be used as the anode and oxygen may be used as a cathode. Oxygen is consumed to form hydroxide ions when the fuel cell is discharging electricity. Thus, there must be a continuous supply of oxygen during the operation. Conversely, oxygen is generated and vented when the cell is recharged. Therefore, fuel cells are designed as open systems to permit intake and venting of oxygen. This open design leads to a water management problem when the ambient humidity is lower than the equilibrium humidity of the electrolyte in the cell. The cell gradually dries out, while in the later case, the electrolyte is diluted or even overflows from the cell. The life span of a cell can be dramatically impaired when an imbalance of water occurs. Conversely, when the relative humidity is higher than about 65 percent, the system can gain water from the wet air and flood.

Previously, water loss has been reduced in fuel cells, or metal air batteries, by restricting the size of openings into the fuel cell. According to this method, the openings may be as small as a few dozen micrometers in diameter. The restricted opening may reduce water evaporation, but also restricts gas flow. A fan can be added to move gas and vapor within the fuel cell to overcome the restricted opening size. But, fans reduce efficiency of the fuel cell due to the fan energy consumption. Another water loss control is through the use of a selective permeation membrane made of a metal oxide, such as tin oxide. The pore size in the metal oxide membrane is too small to allow the flow of enough oxygen. This limits the power of such cells. Another approach is to add a hygroscopic chemical, such as KOH solution. The increased hydrogen bonding and the increased viscosity results in a reduction in the rate of water loss. However, this is still not a satisfactory solution since the cell can still dry out over time.

It may be desirable to have a device that is able to create and/or maintain a stable humidity inside a rechargeable fuel cell. Furthermore, it may be desirable to have a method for creating and/or maintaining a stable humidity inside a rechargeable fuel cell.

### BRIEF DESCRIPTION

The invention may include embodiments that may relate to a device capable of creating and/or maintaining a stable humidity inside a rechargeable fuel cell or battery. The invention may also include embodiments that may relate to a method of creating and/or maintaining a stable humidity inside a rechargeable fuel cell or battery.

According to one embodiment, an apparatus is provided that includes a housing having an interior surface. The interior surface defines a volume and contains a plurality of electrodes. An aperture is defined by the housing, and through which an air gas stream can be in fluid communication with at least one of the plurality of electrodes. A humidity-controlling component is in fluid communication with the air gas stream prior to the air gas stream contacting the at least one of the plurality of electrodes, and the humidity-controlling component can control a relative humidity of the air gas stream.

A method includes passing an intake air gas stream over a humidity buffer solution. The humidity of the at least one intake air gas stream is adjusted to about the equilibrium humidity relative to the humidity buffer solution. The method includes providing the humidity-adjusted stream to at least one electrode in a fuel cell.

### BRIEF DESCRIPTION OF THE DRAWING FIGURES

FIG. 1 is a graphic plot showing a relationship between relative humidity and temperature according to one embodiment;

FIG. 2(a) is a drawing of an embodiment having a tray for containing a humidity buffer solution;

FIG. 2(b) is a graphic plot comparing ambient humidity, the humidity over pure water and the humidity over saturated NaC solution;

FIG. 3 is a graph having a pair of plots showing voltage (top) and current (bottom) discharge profiles of a cell according to an embodiment of the invention;

FIG. 4 is a graph having a pair of plots showing voltage (top) and current (bottom) discharge profiles of a cell according to an embodiment of the invention;

FIG. 5 is an exploded schematic view of an embodiment having a third electrode;

FIG. 6 is an exploded schematic view of another embodiment having a third electrode;

FIG. 7 is a graphic plot showing the effect of the third electrode on discharge capacity;

FIG. 8 is a flowchart showing a process for making a third electrode having a frame structure; and

FIG. 9 is a flowchart showing a process for making a galvanic electrochemical cell having a third electrode.

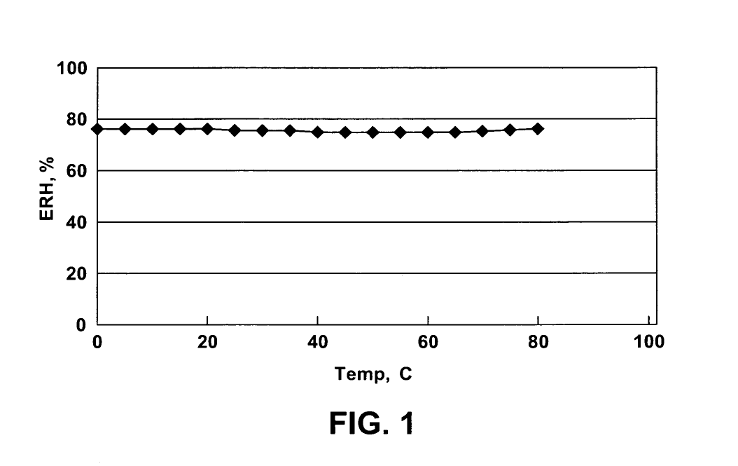

### DETAILED DESCRIPTION

The invention may include embodiments that relate to a fuel cell or secondary battery. In one embodiment, a method associated with the fuel cell or secondary battery is provided.

Approximating language, as used herein throughout the specification and claims, may be applied to modify any quantitative representation that could permissibly vary without resulting in a change in the basic function to which it is related. Accordingly, a value modified by a term such as “about” may not to be limited to the precise value specified, and may include values that differ from the specified value. In at least some instances, the approximating language may correspond to the precision of an instrument for measuring the value. Similarly, “free” may be used in combination with a term, and may include an insubstantial number, or trace amounts, while still being considered free of the modified term.

As used herein the term humidity buffer solution includes a composition of matter that is capable of absorbing excess water from, or adding replacement water to, an electrolyte in contact therewith. This capability may include producing and maintaining an equilibrium humidity at or near that of the selected electrolyte solution. Some humidity buffer solutions may comprise aqueous solutions of one or more organic or inorganic salts. Furthermore, the solvent is not limited to water. Water may be combined with one or more soluble or semi-soluble additives.

As used herein, the term membrane refers to a selective barrier that permits passage of protons and/or hydroxide ions generated at a cathode through the membrane to the anode for oxidation of hydrogen atoms at the anode to form water and heat, unless context or text indicates otherwise.

One embodiment may comprise a tray for holding a humidity buffer solution. The tray may be disposed within a housing with a fuel cell electrolyte solution and can be spaced apart from the fuel cell electrolyte solution. The space or volume between the fuel cell electrolyte solution and the humidity buffer solution may be occupied by a gas phase. According to this embodiment, the gas phase is in contact with both the fuel cell electrolyte solution and the humidity buffer solution. Therefore, water may pass from the humidity buffer solution to the fuel cell electrolyte solution, or from the fuel cell electrolyte solution to the humidity buffer solution. Accordingly, as the fuel cell electrolyte solution loses water, the losses can be compensated by drawing replacement water from the surrounding gas phase. Furthermore, the surrounding gas phase may maintain a substantially constant relative humidity because it may draw replacement water from the humidity buffer solution. Conversely, if the fuel cell collects, absorbs, or creates excess water, the excess can be expelled from the electrolyte solution by vaporizing it into the surrounding gas phase. Furthermore, the surrounding gas phase may maintain a substantially constant relative humidity because it may release water to the humidity

Humidity control materials can provide a stable humidity that can be suitable for rechargeable fuel cells. Suitable humidity control materials include saturated solutions of organic or inorganic salts, drying agent solutions, polymer gels, and inorganic colloids. Suitable humidity buffer solutions can comprise one or more alkaline earth metal salt, which may be a halide, sulfate, carbonate, nitrate, or caboxylate. Suitable salt solutions may include one or more of CaSO₄, LiCl, CH₃COOK, MgCl₂, KCO₃, Mg (NO₃)₂, NaBr, CoCl₂, NaNO₂, SrCl₂, NaNO₃, NaCl, KBr, (NH₄)₂SO₄, KCl, Sr(NO₃)₂, BaCl₂, KNO₃, or K₂SO₄. The humidity buffer solution may be a saturated solution. In one embodiment, the saturated solution may consist essentially of one or more of CaSO₄, LiCl, CH₃COOK, MgCl₂, KCO₃, Mg (NO₃)₂, NaBr, CoCl₂, NaNO₂, SrCl₂, NaNO₃, NaCl, KBr, (NH₄)₂SO₄, KCl, Sr(NO₃)₂, BaCl₂, KNO₃, or K₂SO₄. Table 1 sets forth a plurality of humidity buffer solutions that can provide equilibrium humidities in a suitable range of humidities.

TABLE 1
Equilibrium humidity of saturated salt solutions

| SALT | 25° C. | 30° C. |
|---|---|---|
| CaSO₄ | <0.01 | <0.01 |
| LiCl | 0.112 | 0.115 |
| CH₃COOK | 0.227 | 0.225 |
| MgCl₂ | 0.328 | 0.329 |
| KCO₃ | 0.432 | 0.447 |
| Mg (NO₃)₂ | 0.529 | 0.52 |
| NaBr | 0.576 | 0.574 |
| CoCl₂ | 0.649 | — |
| NaNO₂ | 0.643 | 0.649 |
| SrCl₂ | 0.709 | — |
| NaNO₃ | 0.743 | — |
| NaCl | 0.753 | 0.769 |
| KBr | 0.809 | — |
| (NH₄)₂SO₄ | 0.81 | — |
| KCl | 0.843 | 0.85 |
| Sr(NO₃)₂ | 0.851 | — |
| BaCl₂ | 0.902 | 0.92 |
| KNO₃ | 0.936 | — |
| K₂SO₄ | 0.973 | 0.977 |

These compositions may produce equilibrium humidities during use that are in a range of from about 50 percent to 65 percent, 65 percent to about 75 percent, or 75 percent to about 90 percent of the equilibrium humidity of 6M KOH. Such substances can generate a local environment having a humidity that is stable and suitable for maintaining water balance in a rechargeable fuel cell.

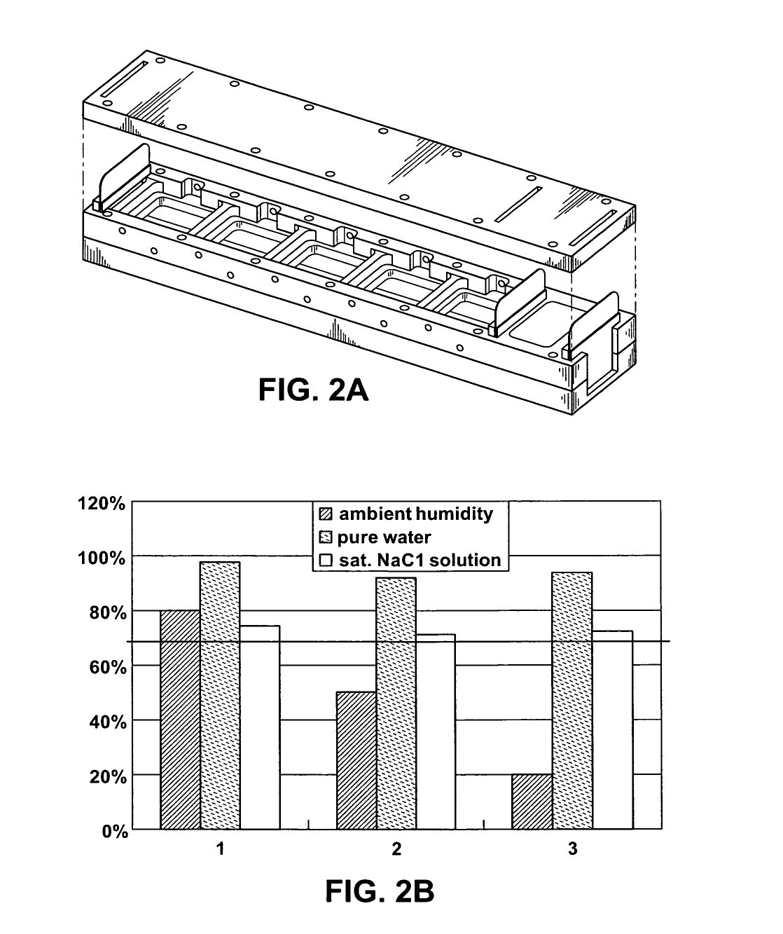

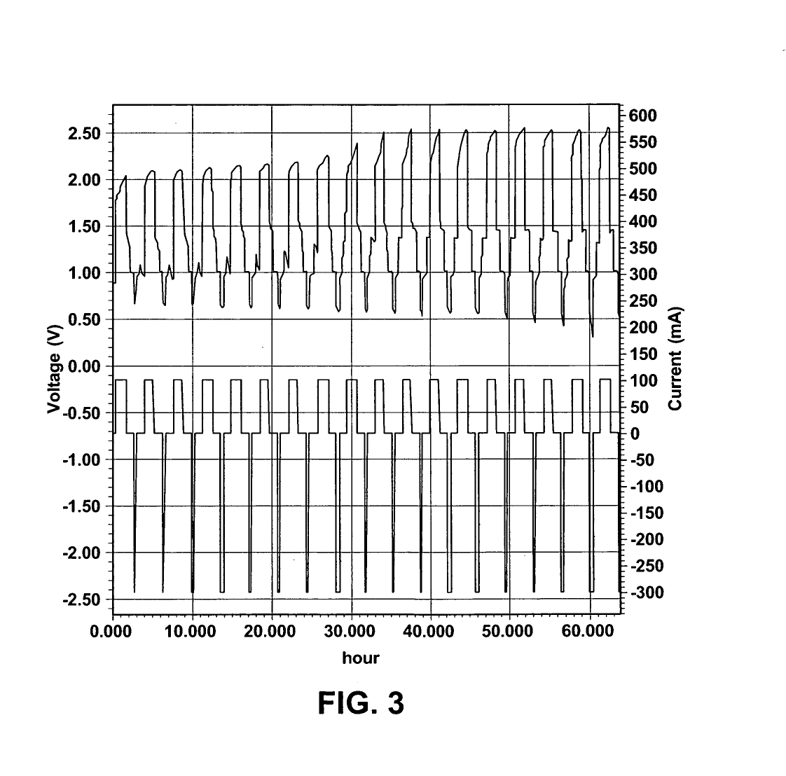

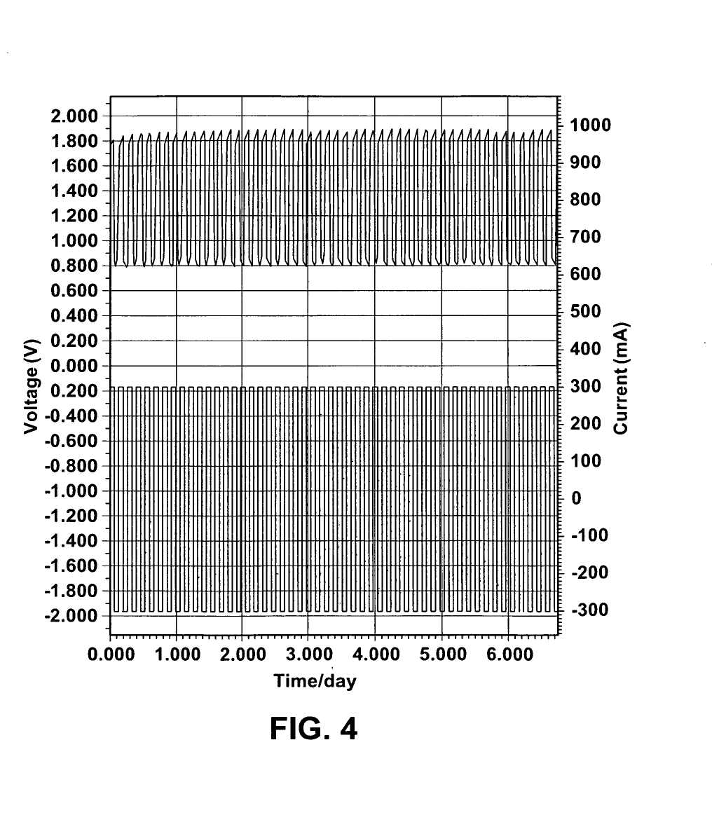

FIG. 2 shows a fuel cell device equipped with a tray or well for holding a humidity buffer solution. The tray can contain any of a variety of saturated salt solutions. According to this embodiment, the tray comprises a part of a fuel cell stack. One side of the cell faces the surface of the humidity buffer solution. The humidity buffer solution provides a stable humidity at or near the equilibrium humidity of the electrolyte.

The humidity buffer solution may further include a hydrophilic additive. Suitable hydrophilic additives may include a polyacrylate, for example, sodium polyacrylate (PAA Na) CAS#: 9003-04-7. Additionally or alternatively, other suitable hydrophilic additives may include one or more alcohols, amines, ethers, or cellulosics. Suitable alcohols may be polyols, such as polyethylene glycol. In one embodiment, the hydrophilic additive may include one or more of glycerin, carboxymethyl cellulose (CMC), or polyethylene oxide. In one embodiment, the hydrophilic additive may include one or more of polyacrylamide, polyvinyl alcohol or poly(vinyl acetate). The hydrophilic additives may include one or more functional groups that are effective for bonding with water. Suitable functional groups may include one or more of OH—, carboxyl, ether, and NH— functional groups. In one embodiment, more than one type of functional group is present on a single molecule.

The PAA Na, glycerin, polyethylene oxide, carboxymethyl cellulose (CMC), alcohols and amine additives may be soluble in water. The chemical formula for PAA Na is:

—[CH₂—CH(COONa)]ₙ.

The chemical formula for carboxymethyl cellulose (CMC) is:

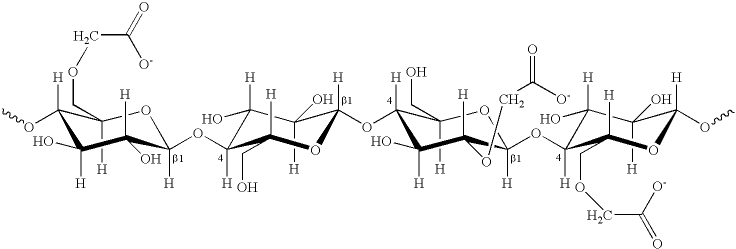

Suitable hydrophilic additives may have a molecular weight of up to about 3,000,000. In one embodiment, the hydrophilic additive average molecular weight may be in a range of from about 50,000 to about 500,000; from about 500,000 to about 750,000; from about 750,000 to about 1,000,000; from about 1,000,000 to about 1,500,000; from about 1,500,000 to about 2,000,000; from about 2,000,000 to about 2,500,000; from about 2,500,000 to about 2,750,000; or from about 2,750,000 to about 3,000,000.

The hydrophilic additive may be present in the humidity buffer solution in a concentration effective for reducing water evaporation from the electrochemical cell. The hydrophilic additives may be present in the humidity buffer solution in an amount of up to about 95 weight percent based on the weight of the humidity buffer solution. In one embodiment, the hydrophilic additive may be present in the humidity buffer solution in an amount in a range of from about 0.5 weight percent to about 1.5 weight percent, from about 1.5 weight percent to about 2.5 weight percent, from about 2.5 weight percent to about 5 weight percent, from about 5 weight percent to about 7.5 weight percent, from about 7.5 weight percent to about 15 weight percent, from about 15 weight percent to about 25 weight percent, from about 25 weight percent to about 50 weight percent, from about 50 weight percent to about 65 weight percent, from about 65 weight percent to about 80 weight percent, or from about 80 weight percent to about 95 weight percent based on the weight of the humidity buffer solution.

During use, the hydrophilic additives may absorb water vapor from air and may retain the water in the humidity buffer solution. The presence of the hydrophilic additives in the humidity buffer solution may reduce the equilibrium vapor pressure of the humidity buffer solution. A relatively lower equilibrium vapor pressure may retain relatively more water in the humidity buffer solution as liquid.

In one embodiment, the humidity buffer solution is potassium hydroxide (KOH) and has a molarity of 6 mol/L. The KOH humidity buffer solution may be mixed with PAA Na to form a KOH/PAA Na/water solution. The solution of KOH/PAA Na/water may absorb water as water vapor from ambient air into the humidity buffer solution, and may retain that water within the electrochemical cell. This absorption of water from water vapor by PAA Na in the humidity buffer solution may results in a net water retention even under conditions where the relative humidity of the vapor environment in the electrochemical cell is reduced because the equilibrium of the system favors retention of water in the humidity buffer solution.

The KOH/PAA Na/water humidity buffer solution may maintain water because when water evaporation increases, forming more water vapor, the KOH and PAA Na concentrations also increase within the humidity buffer solution. As a consequence, evaporation of water from the humidity buffer solution is decreased because the equilibrium vapor pressure for water favors retention of water in the humidity buffer solution. The water concentration increase in the humidity buffer solution continues until the vapor pressure favors water evaporation. This self-regulating water/water vapor dynamic may reduce or prevent a risk of the electrochemical cell drying out. This aspect may maintain a water balance in the cell within a determined range. For some embodiments, the PAA Na showed such effect up to about 800 times its weight in water.

While a KOH/PAA Na/water humidity buffer solution has been described, it is understood by one of ordinary skill in the art that other hygroscopic additives, such as alcohols, amines and glycerin are usable within an aqueous humidity buffer solution.

According to some embodiments, a fuel cell component may derive hydrogen from a solid-state material and water, or from another hydrogen source. A porous metal hydride anode of the fuel cell may be operable for conducting electrons freed from the solid-state hydrogen storage material so that they can be supplied to current collectors. The porous metal hydride anode may include pores, and interstitial spaces that are operable for storing water and electrolyte. The porous metal hydride anode may have an improved charge efficiency occurring as a result of reducing electrolyte transfer. According to some embodiments, porosity may create a volume within the anode for storage of water and/or electrolyte, which may be effective for off-setting water losses due to evaporation and consumption. For example, water may be retained in a porous metal hydride anode fabricated using sintered zinc powder.

The terms cathode and cathodic electrode refer to an electrode this is positively charged during a discharge operation. At the cathode, or cathodic electrode, oxygen from air is reduced by free electrons from the usable electric current, generated at the anode, that combine with water, generated by the anode, to form hydroxide ions and heat. A fuel cell cathode can conduct electrons back from an external circuit to a catalyst, where they combine with water and oxygen to form hydroxide ions. The catalyst may be operable for facilitating the reaction between hydrogen and oxygen. The catalyst may comprise materials including, but not limited to, platinum, palladium and ruthenium, which face the separator membrane. The surface of the platinum may be such that a maximum amount of the surface area may be exposed to oxygen. Oxygen molecules are dissociated into oxygen atoms in the presence of the catalyst and accept electrons from the external circuit while reacting with hydrogen atoms, thus forming water. In this electrochemical reaction, a potential develops between the two electrodes.

A hydrogen-generating component of a hybrid system provides energy storage capacity and shares the porous anodic electrode of the fuel cell component. The hydrogen-generating component further may include an electrode and a separator membrane. The structure of the hydrogen-generating component may be a construction including one or more identical cells, with each cell including at least one each of an electrode, anodic electrode, and separator membrane. The anodic porous electrode may include a hydrogen storage material and may perform one or more functions, such as: (1) a solid-state hydrogen source for the fuel cell component; (2) an active electrode for the hydrogen-generating component; and (3) a portion or all of the electrode functions as an anode of the anode component.

The electrochemical hydrogen-generating component has storage characteristics characterized by being capable of accepting direct-current (DC) electrical energy in a charging phase to return the solid-state material to a hydrogen-rich form, retaining the energy in the form of chemical energy in the charge retention phase, and releasing stored energy upon a demand by the fuel cell component in a discharge phase. The hydrogen-generating component may repeatedly perform these three phases over a reasonable life cycle based on its rechargeable properties. The electrical energy may be supplied from an external source, a regenerative braking system, as well as any other source capable of supplying electrical energy. The solid state material may be recharged with hydrogen by applying the external voltage.

Suitable metal hydrides may include one or more of AB₅ alloy, AB₂ alloy, AB alloy, A₂B alloy, A₂B₁₇ alloy, or AB₃ alloy. The AB₅ alloy may include, but is not limited to, LaNi₅, CaNi₅, or MAₓB_{y}C_{z}, wherein M may be a rare earth element component; A is one of the elements Ni or Co; B may be one of the elements Cu, Fe or Mn; (it is noted that as used herein “C” does not stand for elemental carbon) C may be one of the elements Al, Cr, Si, Ti, V or Sn. And, x, y and z satisfy one or more of the following relations, wherein 2.2≦x≦4.8, 0.01≦y≦2.0, 0.01≦z≦0.6, or 4.8≦x+y+z≦5.4. Suitable examples of AB₂ type alloys include, but are not limited to, Zr—13 V—Ni, Zr—Mn—Ni, Zr—Cr—Ni, TiMn, and TiCr. Suitable AB type alloys include, but are not limited to, TiFe and TiNi. Suitable A₂B type alloys include, but are not limited to, Mg₂Ni. Suitable A₂B₁₇ type alloys include, but are not limited to, La₂Mg₁₇. Suitable AB₃ type alloys include, but are not limited to, LaNi₃, CaNi₃, and LaMg₂Ni₉.

In one embodiment, the anode material may include catalyzed complex hydrides. Suitable complex hydrides may include one or more of borides, carbides, nitrides, aluminides, or silicides. Suitable examples of complex catalyzed hydrides may include an alanate. Suitable alanates may include one or more of NaAlH₄, Zn(AlH₄)₂, LiAlH₄ and Ga(AlH₄)₃. Suitable borohydrides may include one or more of Mg(BH₄)₂, Mn(BH₄)₂ or Zn(BH₄)₂. In one embodiment, the anode material may include complex carbon-based structures or boron-based structures. Such complex carbon-based structures may include fullerenes, nanotubes, and the like. Such complex boron-based structures may include boron nitride (BN) nanotubes, and the like.

Sacrificial additives may be selected to control the pore volume and/or the pore configuration. For example, a weight of sacrificial additives may be selected to control pore volume. That is, the more of the sacrificial additive used, the more pore volume is generated when the sacrificial additive is removed. As another example, a type of sacrificial additive may be selected to control pore configuration. That is, the configuration of the sacrificial additive selected may control the pore configuration when the sacrificial additive is removed. The configuration may include such attributes as interconnectivity, diameter, length, spacing, and the like.

In one method embodiment, metal hydride powder may be mixed with a conductive additive. Suitable conductive additives may include, for example, nickel or cobalt.

A determined amount of sacrificial additives may be added to form a mixture. The amount may be determined with reference to the desired pore volume of the end product. That is, an amount of the sacrificial additives having a known volume may be used to produce a corresponding desired volume in the end product. Suitable sacrificial additives may include one or more of zinc, aluminum, nickel, or carbon. In one embodiment, the sacrificial additives may include one or more of zinc acetate, aluminum acetate, or nickel acetate. In one embodiment, the sacrificial additives may include a carbonate, such as NH₄HCO₃.

The mixture may be pasted, formed, and/or pressed to form an anode electrode precursor structure. The anode electrode precursor structure may be heated. The heating may calcine and/or sinter the precursor structure to form an electrode main body. The sacrificial additives may be partially or entirely removed during, or after, the sintering and/or calcining process. If removed during, the heat of calcining and/or sintering may vaporize the sacrificial additives. If removed after, the sacrificial additives may be solvated or the like. Excipient salts may be useful for solvated removal after heating. The removal of the sacrificial additives may leave a porous metal anode electrode main body having a determined pore volume.

In one embodiment, the sacrificial additive may be selected to have an effect on the inner surface of the pores formed by the removal of the sacrificial additive. In such an instance, the composition of the sacrificial additive may be entirely or partially devoted to affecting the surface character of the pore. For example, if a metal particle is added to the sacrificial additive, which is otherwise a volatile low polymer, heating to vaporize the sacrificial additive may release the metal particle from the matrix of the sacrificial additive and the metal particle may deposit on the pore inner surface. Thus, the pore inner surface composition and character may be controlled. In one embodiment, a material is deposited on the pore inner surface that readily forms surface hydroxyl groups. The surface hydroxyls may increase the hydrophilicity of the pores and facilitate transport of polar liquids therethrough. In one embodiment, a selected catalyst may be deposited on the pore inner surface. It may be desirable to coat the outer surface of the sacrificial additive, which will contact and define the inner surface of the pore, with the material to be deposited.

During use, the pores may receive and store water and/or electrolyte. Suitable electrolytes may include aqueous KOH. The anode electrode main body may have a pore volume capable of storing quantities of water and electrolyte suitable for use in a rechargeable fuel cell or a metal hydride based battery. The pore volume may be greater that about 5 percent of the volume of the anode electrode main body. In one embodiment, the pore volume may be in a range of from about 5 percent to about 10 percent, from about 10 percent to about 15 percent, from about 15 percent to about 20 percent, from about 20 percent to about 25 percent, from about 25 percent to about 35 percent, from about 35 percent to about 45 percent, from about 45 percent to about 55 percent, or from about 55 percent to about 75 percent of the volume of the anode electrode main body.

Embodiments of the porous metal hydride anode may have a relatively improved charge efficiency resulting from a reduced electrolyte transfer. Electrolyte transfer may refer to the tendency of the electrolyte to migrate from the positive end proximate the cathode to the negative end proximate the anode during use. In a stack, particularly, the end cells may lose performance relative to the centrally located cells due to such migration, which may cause a concentration imbalance. By providing a physical obstacle to flow, in the form of a tortuous path and constricted pathways, electrolyte migration may be controlled, and thereby electrolyte transfer may be reduced.

Thus, some porous metal hydride electrode embodiments can store additional KOH electrolyte and can serve as anodes after being positioned with a membrane separator, air cathode electrode and other components and assembled into a rechargeable fuel cell. The additional quantity of KOH electrolyte stored in porous anode embodiments can reduce the water management concerns caused by the consumption and evaporation of water during the charge and discharge processes. At the same time, the use of porous anode embodiments in a rechargeable fuel cell improves the energy conversion and energy transfer efficiency of the fuel cell. The porous anode is also usable in fuel cells that are not rechargeable.

In one aspect, an embodiment may include a method for making a porous anode for use in a rechargeable fuel cell. The method may include, preparing a mixture. The mixture may include metal hydride and one or more sacrificial additives. For some embodiments, a gel binder may be added as part of the sacrificial additive. The additives may be sacrificial insofar as they may be subsequently removed during sintering and/or calcining, completely or in part, to form the pores of the porous anode.

The metal hydride and sacrificial additive mixture may be formed into a porous electrode main body, or green body. The green body may be sintered. Sintering may obtain a stable and strong connection among the metal hydride particles. Hydrogen gas may be introduced during sintering to reduce or prevent metal hydride oxidation. The sacrificial additive may be introduced during mixing, and may be removed during sintering and/or calcining. Alternatively, the sacrificial additive may be removed by other removal steps without sintering.

The metal hydride and sacrificial additive mixture may be paste sintered. In this paste-sintered embodiment, a mixture of metal hydride and sacrificial additive may coat a metal foam plate, and may be paste sintered at a relatively high temperature.

In one embodiment for paste sintering, a nickel metal hydride may be mixed with a zinc sacrificial additive, forming a metal hydride mixture. The metal hydride mixture may be applied to a nickel foam. The wet coated nickel foam plate may be dried to form an electrode main body. The main body may be sintered at about 800 degrees Celsius. In one embodiment, the metal hydride mixture may be mixed further with a binder. Suitable binders may include styrene butadiene rubber and nickel. The mixed composition may be cold pressed onto the nickel foam plate to form a cold pressed assembly. The cold press assembly may be cold press sintered at a lower temperature than the temperature used for paste sintering.

The temperature range for paste sintering may be from about 100 degrees Celsius to about 800 degrees Celsius. The temperature range for cold press sintering may be in a range of from about 100 to about 300 degrees Celsius. Binders such as gel binders, styrene butadiene rubber, and carboxymethyl cellulose may be added to the cold press assembly and may be sintered at a temperature in a range of from about 500 degrees Celsius to about 800 degrees Celsius. Sacrificial additives may be added to the mixture before it is formed green structure, which may be further processed to become the electrode main body.

The sintered anodes may be treated to remove sacrificial additives. The treatment may include sonication, acidification, solvation, or dissolution by heat decomposition. Additive removal schemes for removing additives in an alkaline environment with sonication include treating with zinc or aluminum as follows:

Zn+2OH⁻→ZnO₂⁻+H₂

Al+2OH⁻→AlO2⁻+H₂

### The treatment with an alkaline material forms Zn and Al ionic species, which may be washed away.

Additive removal schemes for removing additives in an acidic environment with sonication may include treating with zinc or aluminum or ammonium carbonate as follows:

Zn+2H⁺→Zn²⁺⁺H₂

Al+2H⁺→Al³⁺+H₂

### When Zn and Al are exposed to an acidic environment, zinc ion and aluminum ion, respectively, may be formed with hydrogen gas.

In one method embodiment, a sacrificial additive of aluminum powder may be mixed into anodic metal hydride material to form a mixture. The mixture may be coated onto a nickel foam and pressed to form an anode having a thickness of, In one embodiment, about 3 mm. The anode may be soaked in an alkaline solution to remove the aluminum. The soaked anode may be sintered in a mixture of argon gas and hydrogen gas, for some embodiments. For other embodiments, the anode may not be sintered.

Another method embodiment may include mixing NH₄HCO₃ into anodic metal hydride material, coating the mixture onto nickel foam and pressing to form an anode. In one embodiment, the thickness of an anode may be about 3 mm. The pressed anode may be heated at a temperature of about 60 degrees Celsius to remove the NH₄HCO₃ with the removal scheme below.

NH₄HCO₃→NH₃+CO₂+H₂O

Another method may include mixing nickel acetate into anodic metal hydride material, coating the mixture onto a nickel foam plate to form an anode. The anode may be heated to about 500 degrees Celsius to remove acetate ions, and form a porous anode with the removal scheme below. In another embodiment, the anode may be pressed to form an anode having thickness of about 3 millimeters (mm). The pressed anode may be heated to about 500 degrees Celsius to remove acetate ions, for example with the removal scheme below.

Ni(CH₃COO)_{2 l +H}₂43 Ni+C+CO₂+H₂O

The pore volume of the porous anode may be determined by selecting a quantity of sacrificial additive, such as aluminum and zinc that produce the pore volume. The mechanical strength of the porous anode may be determined by selecting the pressure and time of sintering. The sintering effect may be affected by controlling the temperature and the time of sintering. The sintering process may destroy or chemically alter the binders, such as polytetrafluoroethylene and carboxymethyl cellulose.

In one embodiment, hydrogen and/or oxygen may be required by a fuel cell component to produce electrical energy. A rechargeable fuel cell may be operated with solid-state materials capable of hydrogen storage, such as, but not limited to, conductive polymers, ceramics, metals, metal hydrides, organic hydrides, a binary or other types of binary/ternary composites, nanocomposites, carbon nanostructures, hydride slurries and any other advanced composite material having hydrogen storage capacity. Recharging of a rechargeable fuel cell may produce water and/or oxygen, which may be recycled. The electrochemical system may require cooling and management of the exhaust water. The water produced by the fuel cell component may recharge the solid-state fuel. For some embodiments, the only liquid present in the rechargeable fuel cell may be water or water-based solutions. Water management in the non-woven separation membrane may be useful. Because the membrane may function better if hydrated, the fuel cell component may operate under conditions where the water by-product does not evaporate faster than it may be produced. The porous metal anode embodiments described herein may aid in the maintenance of membrane hydration.

The rechargeable fuel cell embodiment described herein applies to power generation in general, transportation applications, portable power sources, home and commercial power generation, large power generation and to any other application that would benefit from the use of such a system.

While a fuel cell/hydrogen generator hybrid design may be shown, it may be understood that other rechargeable fuel cell embodiments may include the porous metal hydride anode. The rechargeable fuel cell described may be operable for converting electrical energy into chemical energy, and chemical energy into electrical energy.

A third electrode may include a material with low oxygen evolution over-potential. The third electrode may include one or more ferro-based alloys. Suitable ferro-based alloys may include stainless steel. Other examples of suitable materials may include one or more of cadmium, palladium, lead, gold, or platinum. The material may be configured to increase surface area, such as by foaming. A suitable example would be a nickel-based foam. Foams may enhance an ability of storing electrolyte solution within the volume of its pores, may provide an increased surface area for reaction, and may provide for diffusion control.

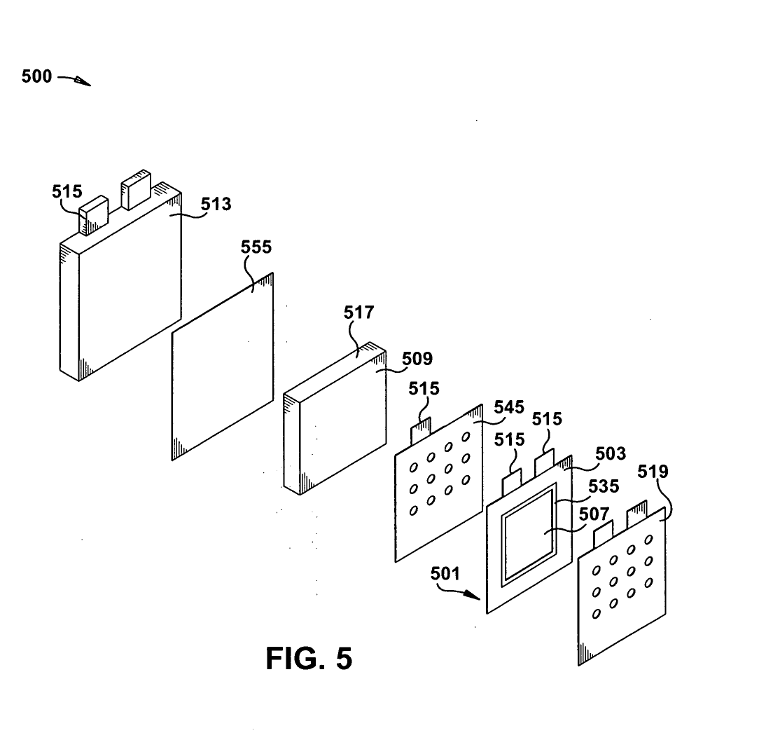

Referring to FIG. 5, an exploded view of an assembly 500 of cathode 507 and third electrode assembly 501 utilized in a galvanic cell are shown. The cathode 507 and third electrode assembly 501 may include a cathode 507 surrounded on the perimeter by a separator 535. The third electrode 503 further surrounds the separator 505 in a single plane with the cathode 507.

The third electrode frame structure 501 may be in contact on a first side with a second separator 545, which may be in contact with an anode 509. The anode 509 may contact both electrodes of the third electrode frame structure 501, through the second separator 545, despite the cathode 507 and third electrode 503 being electrically insulated from one another. A sealing ring 517 may be positioned on the perimeter of the anode 509. The anode 509 may contact a third separator 555. An air permeable cover 519 and support cover 513 may structurally support the cell. Water filling ports and electrical connections 515 may be incorporated to complete the cell.

The covers may function as a plastic housing. The plastic housing may be moldable to reduce cost and to simplify manufacturing. The covers/housing 513 and 519 may include polyethylene or polypropylene, for example. Such materials allow for a caustic resistant housing for the cell and its components. The moldable housing may provide relatively efficient sealing. In one embodiment, the plastic housing may be thermoset. Thus, the plastic housing may be formed by, for example, resin injection molding (RIM) or from a bulk molding compound (BMC).

Applying a voltage between the anode and the third electrode of the cell and reversing the electrochemical reaction may recharge an electrically rechargeable fuel cell or metal/air battery. During recharging, the cell may generate oxygen. Generated oxygen may be released to the atmosphere through the air permeable cathode if desired.

The mechanism of a rechargeable fuel cell or metal/air battery may be shown below.

In charging process:

| | |
|---|---|
| negative electrode: | 4M + 4H₂O + 4e → 4MH + 4OH⁻ |
| third electrode: | 4OH⁻ → O2 + 2H₂O + 4e |
| total electrolysis reaction: | 4M + 2H₂O → 4MH + O₂ |

In discharging process:

| | |
|---|---|
| negative electrode: | 4MH + 4OH⁻ + 4e → 4M + 4H₂O |
| positive electrode: | O₂ + 2H₂O + 4e → 4OH⁻ |
| total cell reaction: | 4MH + O₂ → 4M + 2H₂O |

The cathode may be used during the discharge cycle, but may be inefficient in recharging the cell. Further, the cathode may deteriorate quickly when used to recharge. In one embodiment, a third electrode may be utilized as a separate oxygen generation electrode. According to some embodiments, a third electrode may be utilized to extend the cycle life over traditional structures by chemically and mechanically protecting the cathode from degradation during recharge. The charge process takes place between the anode and the third electrode. The discharge process takes place between the anode and the cathode. Therefore, the cathode can be free from damage during the oxygen evolution reaction.

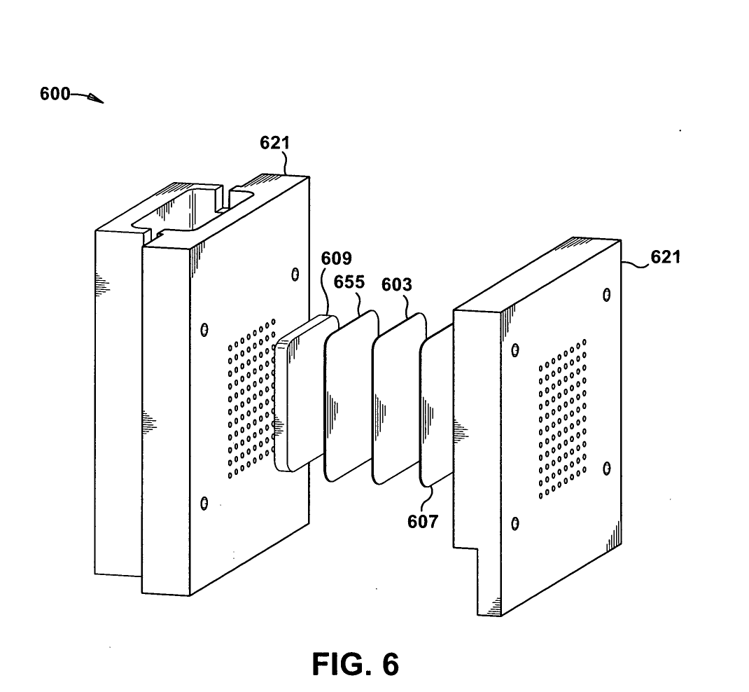

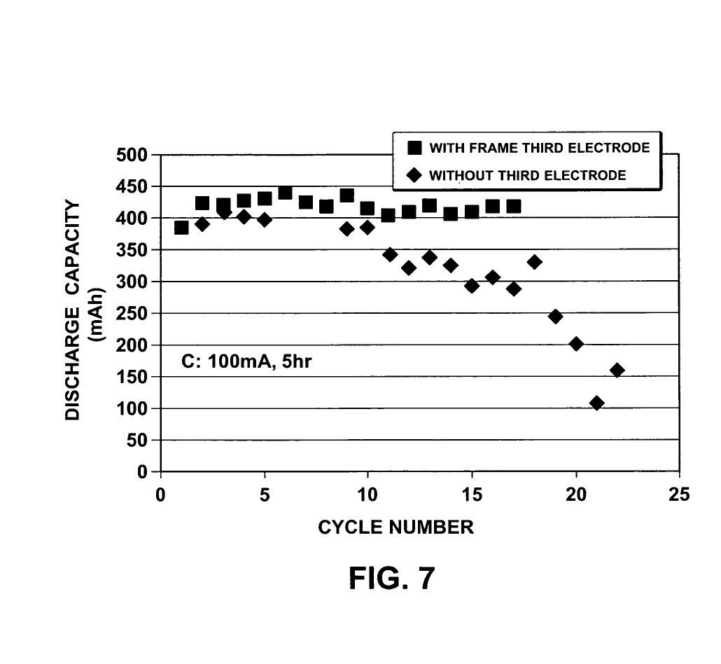

Referring to FIG. 6, an exploded view of a galvanic cell embodiment having a third electrode frame structure is shown. Current collectors 621 on the cathode 607 side contact a cathode 607 and a third electrode 603 separately. That is, two electrically insulated leads stretch out from cathode 607 and frame third 603 separately. Both the third electrode 603 and the cathode 607 may be separated from an anode 609 by a separator 655. FIG. 7 shows a plot of the cycle life of the foregoing galvanic cell. The galvanic cell may utilize the assembly of the cathode and the third electrode assembly. The cell may be compared to a cell in the absence of the third electrode 603. The graph displays the extended cycle life provided by the third electrode 603.

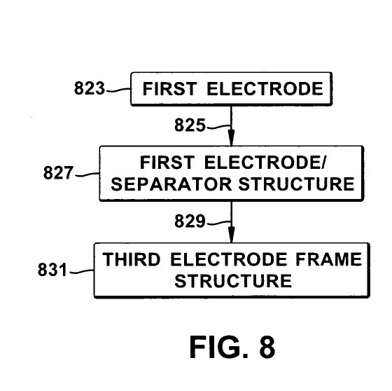

Referring to FIG. 8, a process for making a third electrode frame structure is shown. A first electrode 823 secures to a peripheral edge of a separator 825 on a perimeter to create a first electrode/separator structure 827. The structure 827 secures to a peripheral edge of a third electrode 829 on a perimeter to provide a third electrode frame structure 831 in which the electrodes may be positioned in a common plane. In this embodiment, the first electrode is a cathode. The layers may be secured to each other chemically by an adhesive, or mechanically by a fastener.

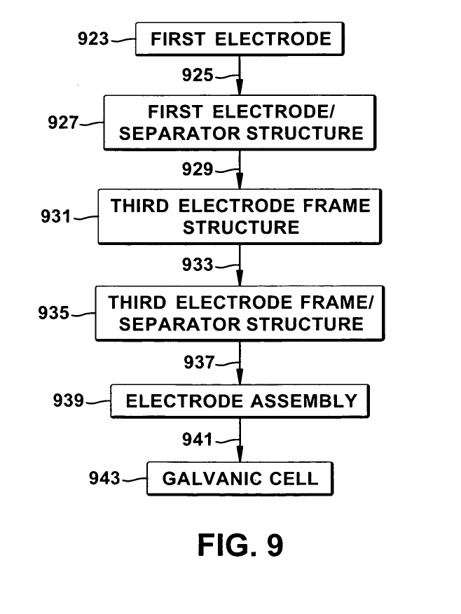

Referring to FIG. 9, a process for making a galvanic cell utilizing a third electrode frame structure is shown. A first electrode 923 secures to a separator 925 on a peripheral edge or perimeter to create a first electrode/separator structure 927. The first electrode/separator structure secures to a third electrode 929 on the outer perimeter to provide a third electrode frame structure 931. The frame structure has the electrodes oriented to be coplanar, or about coplanar. The third electrode frame structure secures to a second separator 933 to provide a third electrode frame/separator structure 935. The third electrode frame/separator structure secures to a second electrode 937 to provide an electrode assembly 939. The second electrode may be positioned to contact both electrodes of the third electrode frame structure 931 through at least one separator. The electrode assembly 939 is assembled 941 during molding of a housing structure to provide a galvanic electrochemical cell 943. The moldable housing may provide structural support and electrical support. Further, the housing defines one or more apertures through which reagents (such as electrolyte, water and air) may ingress or egress from the housing interior.

One embodiment may include a separator membrane. The membrane may be an electrically insulating material. In one embodiment, the membrane may have a high ion conductivity. According to other embodiments, the membrane may be stable in alkaline environments. Non-limiting examples of suitable membrane materials include non-woven polyethylene (PE), polypropylene (PP), composites of PE and PP, asbestos or nylon.

In one embodiment, the separator membrane components may be superhydrophobic membranes. “Super-hydrophobicity,” “super-lipophobicity,” “super-amphiphobicity,” and “super-liquid phobicity” all refer to properties of substances that cause a liquid drop on their surface to have a contact angle of 150 degrees or greater. Depending upon context, the liquid drop can include, e.g., a water or water-based drop (super-hydrophobicity), a lipid-based drop (super-lipophobicity), a water-based or lipid-based drop (super-amphiphobicity), or other liquids. Super-liquid phobicity comprises a generic term indicating a substance that causes a fluid drop (e.g., lipid-based, aqueous-based, or other) to have a greater than 150 degrees contact angle.

One embodiment provides a stable environment with substantially invariable humidity. Another embodiment may prevents both dry-out and flooding of fuel cell electrolyte solutions. Yet another embodiment provides a member and/or assembly for manually adding water in the cell.

In one embodiment, may comprise a nickel metal hydride battery and/or fuel cell technologies. It may utilize metal hydride as an anode and/or an air electrode as cathode so that it has improved energy density, cost and environmental impact in comparison to other batteries.

### EXAMPLES

Presented below are specific examples of methods for making porous metal hydride anode embodiments. These examples are presented to provide additional specific embodiments and not to limit embodiments of the invention.

### Example 1

### Pellet Formation

A quantity of 10 grams (g) of as-received metal hydride alloy powder is mixed with 4.24 grams of nickel acetate, to form a metal mixture. The metal hydride alloy powder MH is (AB₅: MMNi_{4.65}Co_{0.88}Mn_{0.45}Al_{0.05}) alloy powder. The metal mixture is added to 7.12 grams of gel to form a metal gel mixture. The gel is made by adding polytetrafluoroethylene (PTFE) and carboxymethylcellulose (CMC) into water. Stirring the metal gel mixture at 500 revolutions per minute (RPM) for 30 minutes forms a metal hydride (MH) slurry.

A thin film of the MH slurry is painted onto one surface of a clean 3×3 square centimeter plate. The plate is made of foamed nickel. The wet film is dried to a dry thin film layer at 80 degrees Celsius for 5 min. Another wet film of the MH slurry is prepared in the same way as described above and painted onto a surface on the other side of the same Ni foam plate. The second wet film is dried at the same conditions as the first wet film. The steps above are repeated with the slurry wet films, until a uniform dry film layer of a determined thickness is formed on both sides of the Ni foam to make a pellet. The pellet is then dried at 120 degrees Celsius in vacuum overnight to form a green pellet.

The green pellet is calcined in a tube furnace. After the calcinations, the porous calcined pellet appears black in color. The process is repeated to form Samples 1 and 2.

### Example 2

### Electrode Formation

A metal mixture is prepared and added to a gel as described in EXAMPLE 1. EXAMPLE 2 differs in that rather than 7.12 grams of gel, 5 grams of gel are added to form a metal gel mixture. The metal gel mixture is stirred and dried at 80 degrees Celsius. The stirring and drying processes are repeated until the metal gel mixture is evenly mixed and thoroughly dried.

Half of the dried mixture is added to a 3×3 square centimeters mold. A Ni foam plate having the same size as is used in EXAMPLE 1 is then added into the mold. The other half of the metal gel mixture is placed on the top of a Ni foam plate to form a sandwich arrangement. The sandwich may be pressed under determined conditions as indicated in Table 1. The procedure can repeat six times at varying pressures and/or for varying times to form the samples set forth in Table 1. A pressing procedure is as follows:

TABLE 1
Pressing conditions to form the green pellet.

| Sample | Conditions |
|---|---|
| 3 | 2 MPa, 2 min |
| 4 | 4 MPa, 2 min |
| 5 | 6 MPa, 2 min |
| 6 | 8 MPa, 2 min |
| 7 | 10 MPa, 2 min |
| 8 | 12 MPa, 5 min |

The green pellet may be calcined in a tube furnace. After calcination, the pellet color may be black. The pressed sample may be calcined according to the following procedure:
1. Heat from room temperature to about 450 degrees Celsius at about 2 degrees Celsius per minute ramp rate, and maintained at about 450 degrees Celsius temperature for about 30 minutes.
2. Heat from about 450 degrees Celsius to about 500 degrees Celsius within about 30 minutes, and keep at about 500 degrees Celsius for about six hours.
3. Cool to about room temperature at a ramp rate of about 5 degrees Celsius per minute.

As-prepared MH electrodes are weighed before put into 6 molar (M) potassium hydroxide (KOH) solutions. After soaking for 2 hours, the electrodes are each weighed to determine how much KOH is absorbed to the surface and into the pores.

### Example 3

### System Formation

A working example of the humidity controlling system is set forth in FIG. 2(a). The inside relative humidity (RH) is measured using a prototype with end openings at ambient humidity: about 20 percent, 50 percent and 80 percent. A stable internal humidity is obtained. Saturated NaCl solutions provide a stable humidity of about 73 percent. Pure water provides a stable humidity of about 90 percent. The cycle life for a single cell is measured in RH 45 percent and RH 78 percent respectively. The results show the higher humidity increases lifetime.

A humidity control system manages water. Humidity controlling materials include saturated organic and/or inorganic salt solution, or polymer gels. Means for accommodating such materials include, but are not limited to, porous ceramics, particle pastes, sponges, and polymer gels.

The embodiments described herein are examples of compositions, structures, systems and methods having elements corresponding to the elements of the invention recited in the claims. This written description enables one of ordinary skill in the art to make and use embodiments having alternative elements that likewise correspond to the elements of the invention recited in the claims. The scope thus includes compositions, structures, systems and methods that do not differ from the literal language of the claims, and further includes other compositions, structures, systems and methods with insubstantial differences from the literal language of the claims. While only certain features and embodiments have been illustrated and described herein, many modifications and changes may occur to one of ordinary skill in the relevant art. The appended claims are intended to cover all such modifications and changes.

What is claimed is:

1. An apparatus, comprising:
a plurality of electrodes;
a housing having an interior surface defining a volume in which the plurality of electrodes are disposed, and an aperture defined by the housing through which at least one air gas stream is in fluid communication with at least one of the plurality of electrodes; and
a humidity-controlling component, wherein the humidity-controlling component is in fluid communication with the air gas stream prior to the air gas stream contacting the at least one of the plurality of electrodes, and the humidity-controlling component being capable of controlling a relative humidity of the air gas stream.

2. The apparatus as defined in claim 1, wherein the humidity-controlling component comprises a saturated aqueous solution.

3. The apparatus as defined in claim 1, wherein the humidity-controlling component comprises a metal salt.

4. The apparatus as defined in claim 3, wherein the metal salt comprises an alkali earth metal halide or a rare earth metal halide.

5. The apparatus as defined in claim 3, wherein the metal salt comprises a metal nitrate, a metal sulfate, or a metal phosphate.

6. The apparatus as defined in claim 1, wherein the humidity-controlling component is a solution that comprises one or more salt selected from the group consisting of: lithium chloride, potassium acetate, magnesium chloride, potassium carbonate, magnesium nitrate, sodium bromide, cobalt chloride, sodium nitrite, strontium chloride, sodium nitrate, sodium chloride, potassium bromide, ammonium sulfate, potassium chloride, strontium nitrate, barium chloride, potassium nitrate, and potassium sulfate.

7. The apparatus as defined in claim 1, wherein the plurality of electrodes comprises an anode, a cathode, and a third electrode disposed within the volume.

8. The apparatus as defined in claim 7, wherein the third electrode functions to locate the generation of oxygen spatially distant from the anode during operation.

9. The apparatus as defined in claim 7, wherein a separator membrane is disposed between the aperture and the cathode, wherein the separator membrane allows air to pass into the housing but blocks liquid from flowing out of the housing.

10. The apparatus as defined in claim 7, wherein the anode comprises a hydrogen storage material.

11. The apparatus as defined in claim 1, wherein the housing further comprises a base operable to hold at least one of the plurality of electrodes, a tray disposed proximate to the base, the tray defining one or more spaces for containing the at least one humidity-controlling component, and a cover for the tray that is operable to reduce spillage of the humidity-controlling component from the one or more spaces.

12. The apparatus as defined in claim 1, further comprising a vent configured to allow at least one air gas stream to exfiltrate the housing.

13. The apparatus as defined in claim 1, wherein the humidity controlling solution is contained within a material selected from the group consisting of a porous particulate substance, a zeolite, a natural clay, and an inorganic gel.

14. The apparatus as defined in 1, wherein the humidity controlling solution is contained within a material comprising an organic polymer gel or a porous membrane.

15. A method, comprising:
contacting an intake air gas stream to a humidity buffer solution;
adjusting the humidity of the intake air gas stream to an equilibrium humidity level; and
providing the humidity-adjusted intake air gas stream to at least one electrode in a fuel cell.

16. The method as defined in claim 15, further comprising maintaining a relative humidity of the air gas stream within the fuel cell in a range of from about 50 percent to about 85 percent.

17. The method as defined in claim 15, further comprising generating hydrogen and storing the hydrogen in an anode capable of storing the hydrogen.

18. The method as defined in claim 15, further comprising selecting one or more humidity-controlling component from the group consisting of lithium chloride, potassium acetate, magnesium chloride, potassium carbonate, magnesium nitrate, sodium bromide, cobalt chloride, sodium nitrite, strontium chloride, sodium nitrate, sodium chloride, potassium bromide, ammonium sulphate, potassium chloride, strontium nitrate, barium chloride, potassium nitrate, and potassium sulphate.

19. The method as defined in claim 15, further comprising blocking a flow of liquid water from an air ingress, an air egress, or both an air ingress and air egress of the fuel cell, while allowing the flow of gaseous air.

20. The method as defined in claim 19, wherein separating comprises disposing a separator membrane in an air flow path of the intake air gas stream.

21. An electrochemical cell, comprising:
an air electrode configured to receive an intake air gas stream; and
means for maintaining a relative humidity of the intake air gas stream to be in a range of from about 50 percent to about 85 percent.
